(19) United States
(12) Patent Application Publication
(10) Pub. No.: US 2026/0031419 A1
(43) Pub. Date: Jan. 29, 2026

(54) GAS ADSORBER IN LITHIUM-ION BATTERIES

(71) Applicant: GM GLOBAL TECHNOLOGY OPERATIONS LLC, DETROIT, MI (US)

(72) Inventors: Vamakshi Yadav, Sterling Heights, MI (US); Lei Wang, Rochester Hills, MI (US); Meng Jiang, Rochester Hills, MI (US); Gongshin Qi, Troy, MI (US); Xingcheng Xiao, Troy, MI (US)

(21) Appl. No.: 18/782,532

(22) Filed: Jul. 24, 2024

(51) Int. Cl. H01M 10/52; B01D 53/62; B01D 53/82; B01J 20/04; B60L 50/64; H01M 10/0525; H01M 10/0585; H01M 10/42; H01M 50/211; H01M 50/249

(52) U.S. Cl. CPC H01M 10/52; B01D 53/62; B01D 53/82; B01J 20/041; B01J 20/043; B60L 50/64; H01M 10/0525; H01M 10/0585; H01M 10/4235; H01M 50/211; H01M 50/249; B01D 2253/108; B01D 2253/112; B01D 2253/1124; B01D 2257/504; H01M 2220/20

(57) ABSTRACT

Aspects of the disclosure include lithium-ion cells with gas adsorbers and methods of manufacturing the same. An exemplary vehicle includes an electric motor and a battery pack electrically coupled to the electric motor. The battery pack includes a battery cell that includes an anode layer having an anode active material and an anode current collector, a cathode layer having a cathode active material and a cathode current collector, and a separator positioned between the anode layer and the cathode layer. The battery cell further includes a gas adsorber having a gas adsorbent material. The gas adsorbent material is selected to react with at least one offgas that includes a gas phase cycling byproduct produced when cycling the battery cell to form a compound having a solid phase under a cycling temperature and a cycling pressure of the battery cell.

### INTRODUCTION

The present disclosure relates to battery cell manufacturing, and particularly to the introduction of a gas adsorber in lithium-ion batteries.

Lithium-ion batteries, also known as lithium-ion cells, are a type of rechargeable battery technology that have gained significant attention due to their relatively high energy density and long cycle life compared to other battery chemistries. The anode (negative electrode) in a lithium-ion cell is typically made of graphite, a carbon-based material that can reversibly intercalate and deintercalate lithium ions. The cathode (positive electrode) can be made of various lithium-containing compounds, such as lithium transition metal oxides (e.g., LiCoO₂, LiNiMnCoO₂, etc.), lithium metal phosphates (e.g., LiFePO₄), or other suitable materials that can reversibly intercalate and deintercalate lithium ions.

The electrodes in a lithium-ion cell are separated by an electrolyte, which is typically a lithium salt dissolved in an organic solvent, a solid polymer or solid-state electrolyte. The electrolyte acts as a medium for lithium ion transport between the anode and cathode during charge and discharge processes. Current collectors provide a conductive pathway for electrons to flow between the electrodes and an external circuit. The current collector for the anode is typically made of copper or a copper alloy, while the current collector for the cathode is typically made of aluminum or an aluminum alloy.

During the discharge process, lithium ions deintercalate from the anode and migrate through the electrolyte to intercalate into the cathode material, while electrons flow through the external circuit to power a device. During charging, this process is reversed, with lithium ions being extracted from the cathode and intercalated back into the anode.

### SUMMARY

In one exemplary embodiment a vehicle includes an electric motor and a battery pack electrically coupled to the electric motor. The battery pack includes a battery cell that includes an anode layer having an anode active material and an anode current collector, a cathode layer having a cathode active material and a cathode current collector, and a separator positioned between the anode layer and the cathode layer. The battery cell further includes a gas adsorber having a gas adsorbent material. The gas adsorbent material is selected to react with at least one offgas that includes a gas phase byproduct produced by the battery cell to form a compound having a solid phase under an operating temperature and an operating pressure of the battery cell.

In addition to one or more of the features described herein, in some embodiments, the offgas is carbon dioxide.

In some embodiments, the gas adsorbent material includes an alkaline earth oxide.

In some embodiments, the alkaline earth oxide includes one or more of magnesium oxide (MgO), calcium oxide (CaO), barium oxide (BaO), strontium oxide (SrO), or Beryllium oxide (BeO).

In some embodiments, the compound includes an alkaline earth metal carbonate.

In some embodiments, the gas adsorbent material includes one or more of an alkaline earth oxide, zeolite, or porous foam.

In some embodiments, the gas adsorbent material includes a mass percent in the battery cell that is less than 1 percent a total mass of the battery cell.

In another exemplary embodiment a battery cell includes an anode layer having an anode active material and an anode current collector, a cathode layer having a cathode active material and a cathode current collector, and a separator positioned between the anode layer and the cathode layer. The battery cell further includes a gas adsorber having a gas adsorbent material. The gas adsorbent material is selected to react with at least one offgas that includes a gas phase byproduct produced by the battery cell to form a compound having a solid phase under an operating temperature and an operating pressure of the battery cell.

In addition to one or more of the features described herein, in some embodiments, the offgas is carbon dioxide.

In some embodiments, the gas adsorbent material includes an alkaline earth oxide.

In some embodiments, the alkaline earth oxide includes one or more of magnesium oxide (MgO), calcium oxide (CaO), barium oxide (BaO), strontium oxide (SrO), or Beryllium oxide (BeO).

In some embodiments, the compound includes an alkaline earth metal carbonate.

In some embodiments, the gas adsorbent material includes one or more of an alkaline earth oxide, zeolite, or porous foam.

In some embodiments, the gas adsorbent material includes a mass percent in the battery cell that is less than 1 percent a total mass of the battery cell.

In yet another exemplary embodiment a method can include forming an anode layer having an anode active material and an anode current collector, forming a cathode layer having a cathode active material and a cathode current collector, and forming a separator positioned between the anode layer and the cathode layer. The method further includes forming a gas adsorber having a gas adsorbent material. The gas adsorbent material is selected to react with at least one offgas that includes a gas phase byproduct produced by the battery cell to form a compound having a solid phase under an operating temperature and an operating pressure of the battery cell.

In addition to one or more of the features described herein, in some embodiments, the offgas is carbon dioxide.

In some embodiments, the gas adsorbent material includes an alkaline earth oxide.

In some embodiments, the alkaline earth oxide includes one or more of magnesium oxide (MgO), calcium oxide (CaO), barium oxide (BaO), strontium oxide (SrO), or Beryllium oxide (BeO).

In some embodiments, the compound includes an alkaline earth metal carbonate.

In some embodiments, the gas adsorbent material includes one or more of an alkaline earth oxide, zeolite, or porous foam.

In some embodiments, the gas adsorbent material includes a mass percent in the battery cell that is less than 1 percent a total mass of the battery cell.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2A is a schematic view of an example battery cell in accordance with one or more embodiments;

FIG. 2B is a detailed schematic, cross-sectional view of a portion of the battery cell shown in FIG. 2A in accordance with one or more embodiments;

FIG. 2C is a detailed schematic, top-down view of a portion of the battery cell shown in FIG. 2A in accordance with one or more embodiments;

FIG. 3 is a schematic view of an alternative embodiment of the battery cell shown in FIG. 2A in accordance with one or more embodiments;

FIG. 4 is a schematic view of yet another alternative embodiment of the battery cell shown in FIG. 2A in accordance with one or more embodiments; and

FIG. 5 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Electrodes often incorporate current collectors to supplement or otherwise improve upon the electrical energy storage characteristics of a final integrated device (e.g., a battery). A current collector typically includes a sheet of conductive material (e.g., aluminum foil) to which an active electrode material is attached. An energy storage system such as a battery cell or pouch can include a number of stacked anode current collectors and cathode current collectors, an active material(s) dispersed or otherwise situated on the current collectors, and a sufficient number of separators to prevent shorts between the anode current collectors and cathode current collectors. Thus, in many electrode configurations there is a clear separation between anode and cathode, and each electrode serves a specific function, with electrons flowing from the anode to the cathode through an external circuit.

As the demand for energy storage systems offering higher energy densities, faster charging, and extended operational lifespans increases, driven in part by the proliferation of electric vehicles, significant challenges have been imposed on the materials used in battery cell components. Research and development efforts are continuously directed toward identifying novel materials and manufacturing techniques that can meet escalating demands on battery cells and other energy storage systems.

Lithium-ion cells, for example, are an often relied upon rechargeable battery technology that offers several advantages over other battery chemistries. Lithium-ion cells have relatively high energy densities, enabling longer runtime and range for portable electronics and electric vehicles. Additionally, lithium-ion cells have a low self-discharge rate, allowing them to maintain their charge for an extended period when not in use.

Challenges remain, however, in designing, manufacturing, and operating lithium-ion batteries. For example, high energy lithium-ion battery cells produce gas phase byproducts (inadvertent gas generation) when cycling and storing these cells, eventually compromising the electrochemical performance of these batteries and, if allowed to continue, can lead to cell failure due to internal pressure build-up inside the limited headspace of the cell.

This disclosure introduces a lithium-ion battery having an integrated gas adsorber and methods of manufacturing the same. Rather than allowing gas generation to build unchecked in a lithium-ion battery over many cycling periods (or during storage), gas adsorbers described herein are leveraged to convert one or more of the gap phase byproducts generated by the battery into a solid-phase compound. In other words, this disclosure proposes a new lithium-ion battery design that incorporates gas adsorbent materials inside lithium-ion battery cells to reduce the gas phase accumulation in a lithium-ion battery cell (e.g., during cycling, during storage, etc.), thereby mitigating cell swelling and inner pressure buildup. Advantageously, converting all (or a portion) of the gaseous byproduct species to solids can result in a cell volume reduction that exceeds 90 percent. Other advantages are possible. For example, coating a separator with gas adsorber materials as described herein can result in enhanced thermal stability and hydrogen fluoride (HF) scavenging properties.

The composition and relative concentrations of the gaseous species generated by a battery depends on the specific cell chemistry and materials used in a given application. Thus, in some embodiments, the gas adsorber is selected, based on the respective cell chemistries, to convert a targeted offgas (or a portion of the targeted offgas) to solids. In some embodiments, the targeted offgas (the gas phase byproduct) is the major gas species component of the cycling gasses. In some embodiments, the targeted offgas is the major gas species component of a gas released during a storage period. In some embodiments, the targeted offgas is the major gas species of cycling and storage gasses. For example, and without wishing to be bound by theory, it has been found that the major gas species observed in some lithium-ion cells, such as cells having lithium-manganese-rich (LMR) cathode materials, is carbon dioxide (CO₂). In particular, approximately 94.2 percent of the gas generated is carbon dioxide, with the balance including hydrogen (around 0.7 percent), ethane (around 3 percent), and methane (around 2.1 percent). Thus, in some embodiments, the gas adsorber includes a gas adsorbent material selected to react with carbon dioxide to form a compound having a solid phase under the conditions (temperatures, pressures, etc.) of the respective battery cell. For example, in some embodiments, the gas adsorbent material includes an alkaline earth oxide (e.g., MgO, CaO, BaO, SrO, BeO, etc.), which reacts with carbon dioxide to form a solid alkaline earth metal carbonate (e.g., MgCO₃, CaCO₃, etc.).

The gas adsorbers described herein can be implemented and/or otherwise integrated with lithium-ion battery cells during the cell fabrication process. In some embodiments, the gas adsorber is coated on a separator(s) of a cell. In some embodiments, the gas adsorber is blended into a cathode or anode slurry during the electrode fabrication and/or calendering processes. In some embodiments, the gas adsorber is coated directly onto the cathode and/or anode of a cell. In some embodiments, the gas adsorber is coated on an inner surface of a cell can and/or pouch material. In some embodiments, the gas adsorber is placed in a separated enclosure which itself is placed in the cell. In some embodiments, the separated enclosure is at least partially permeable, allowing off gasses to contact gas adsorber materials within the enclosure.

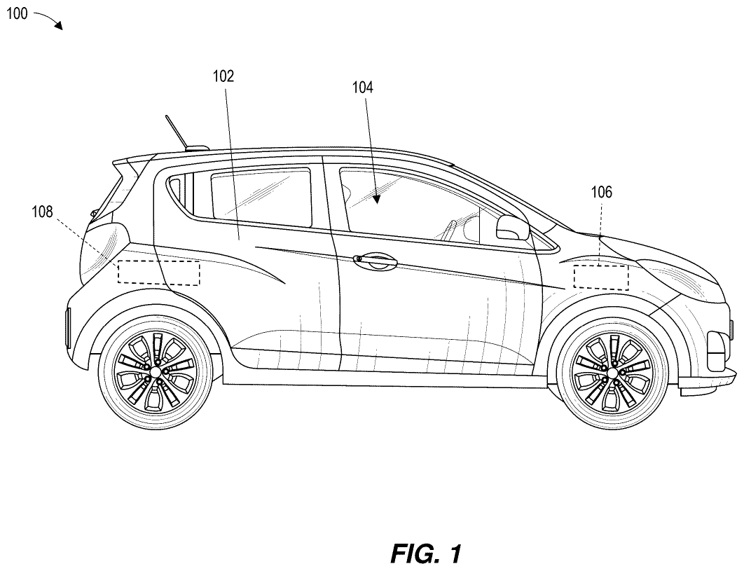

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

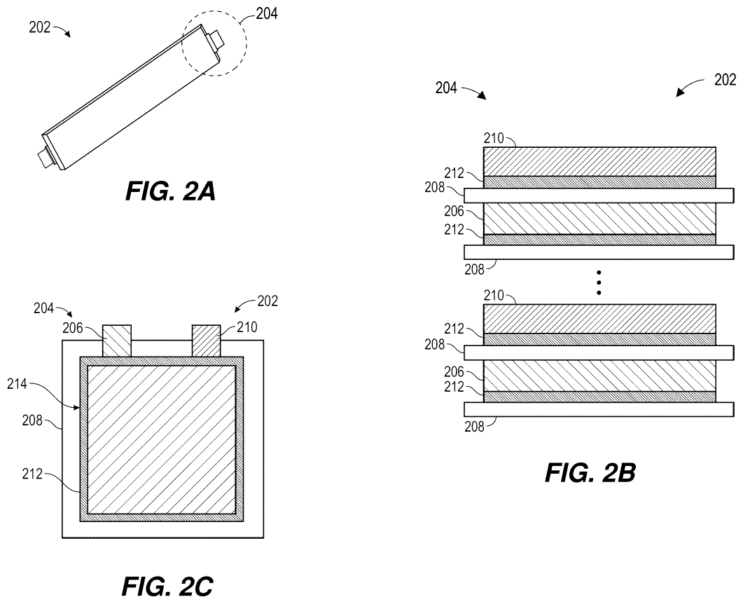

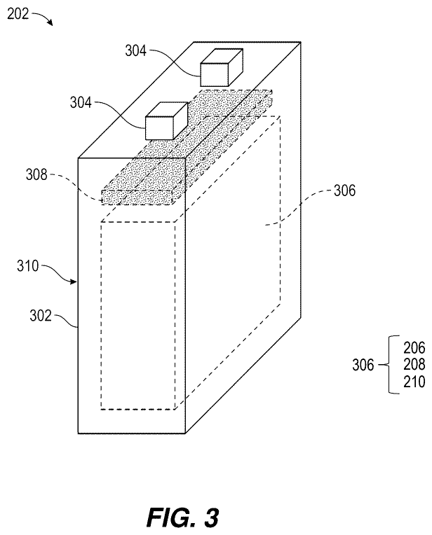

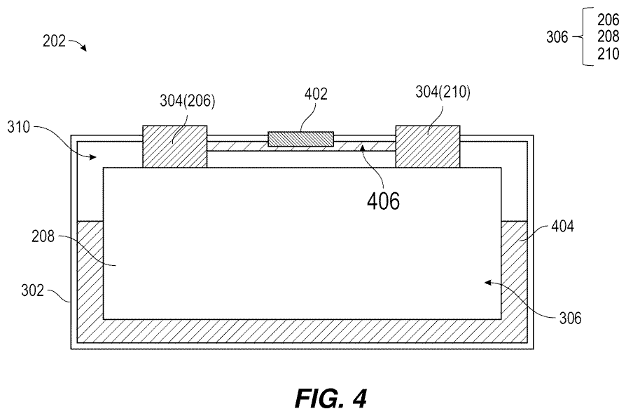

As will be detailed herein, the battery pack 108 includes one or more battery modules and/or battery pouches having an integrated gas adsorber. An example battery cell in a pouch-type configuration is shown in FIG. 2A. Detailed views of the battery cell of FIG. 2A are shown in FIGS. 2B and 2C. An alternative embodiment for a prismatic can-type battery cell having a separate gas adsorber packet is shown in FIG. 3. Yet another alternative embodiment for a prismatic can cell with integrated gas adsorber materials is shown in FIG. 4.

FIG. 2A illustrates an example battery cell 202 in accordance with one or more embodiments. The battery cell 202 can be incorporated as one of a number of battery cells in a battery pack (e.g., the battery pack 108 in FIG. 1). FIG. 2B illustrates a detailed cross-sectional view of a portion 204 of the battery cell 202 shown in FIG. 2A in accordance with one or more embodiments. FIG. 2C illustrates a detailed top-down view of the portion 204 of the battery cell 202 shown in FIG. 2A in accordance with one or more embodiments. As shown in FIGS. 2B and 2C, the battery cell 202 includes one or more anode layer(s) 206, one or more separator(s) 208, one or more cathode layer(s) 210, and one or more gas adsorber(s) 212, configured and arranged as shown.

In some embodiments, the anode layer 206 includes an anode current collector and an anode active material (not separately shown). In some embodiments, the cathode layer 210 includes a cathode current collector and a cathode active material (not separately shown). The anode current collector and the cathode current collector can be made of sheets or foils of conductive materials. For example, the cathode current collector can be made of aluminum foil, stainless steel, and/or titanium foil. Other materials are possible, such as, for example, semimetals (e.g., tin, graphite) and alloys of the metals and/or semimetals thereof. In some embodiments, the cathode current collector is made of aluminum foil. The anode current collector can include, for example, copper foil coated with carbon, such as by one or more graphene layers and/or carbon black layers. In some embodiments, the anode current collector is made of copper foil. Each carbon (graphene, carbon black, etc.) layer thickness can be approximately 1 to 3 nm, although other thicknesses are within the contemplated scope of this disclosure.

The anode active material is not meant to be particularly limited, and can include, for example, lithium metal, activated carbon powder, graphite, silicon, silicon-graphite composites, silicon-carbon composites (Si/C), silicon oxides (SiOₓ), tin, tin oxide (SnO₂), lithium sulfates (Li_{y}SiOₓ), lithium titanate (Li₄Ti₅O₁₂, LTO), and blends and combinations thereof. Similarly, the cathode active material is not meant to be particularly limited, and can include, for example, nickel manganese cobalt oxide (NMC), lithium iron phosphate (LFP), nickel cobalt aluminum oxide (NCA), nickel cobalt manganese aluminum oxide (NCMA), lithium manganese iron phosphate (LMFP), lithium manganese rich (LMR), lithium manganese oxide (LMO), lithium nickel manganese oxide (LNMO), and blends and combinations thereof. In some embodiments, the cathode active material includes materials having a negative electrode capacity to positive electrode capacity ratio (also referred to as the N to P ratio) of between 1 and 3.

In some embodiments, such as for sodium ion battery (SIB) applications, the cathode or anode active materials can include SIB active materials, such as layered- and tunnel-structured transition metal oxides, polyanion compounds, and prussian blue analogs (PBAs), hard carbon materials, such as petroleum coke or mesocarbon microbeads (MCMB), graphite, sodium titanates, such as Na₂Ti₃O₇ and Na_{0.44}MnO₂, tin-based compounds, such as SnO₂ and SnS₂, phosphorus-based compounds, such as phosphorus-carbon composites or phosphorus-based alloys, and combinations thereof.

Depending on battery construction (e.g., conventional vs. bi-polar current collectors, etc.) one or more of the separators 208 are optional but, if included, can be positioned to isolate the anode active materials and the cathode active materials. The separator 208 can include dielectric materials such as, for example, polyethylene (PE), polypropylene (PP), polyethylene terephthalate (PET), and composites thereof, although other dielectrics are within the contemplated scope of this disclosure. In some embodiments, the separator 208 may include a thermally stable coating layer to improve shrinkage behavior (e.g., a porous ceramic coating or porous ester type polymer coating including, for example, polyimide, polyamide, polyimide-polyamide (PI/PA) copolymer, etc.).

While not separately shown, in some embodiments, the battery cell 202 includes an electrolyte. In some embodiments, the electrolyte includes a lithium salt dissolved in a solvent. In some embodiments, the solvent is an organic solvent, although other solvents are possible and within the contemplated scope of this disclosure. The lithium salt is not meant to be particularly limited, but can include, for example, lithium hexafluorophosphate (LiPF₆), lithium bis(trifluoromethanesulfonyl)imide (LiTFSI), lithium bis(oxalato) borate (LiBOB), lithium difluoro (oxalato) borate (LiDFOB), lithium bis(fluorosulfonyl)imide (LiFSI), lithium trifluoromethanesulfonate (LiTf), lithium tetrafluoroborate (LiBF₄), lithium nitrate (LiNO₃), and/or lithium bis(pentafluoroethanesulfonyl)imide (LiBETI), and combinations thereof.

The concentration of the lithium salt(s) in the electrolyte will vary depending on the lithium salt(s) chosen and the needs of a given application. The lithium salt concentration can be varied, for example, to target a predetermined ionic conductivity (increasing the salt concentration leads to an increase in ionic conductivity up to a certain point, beyond which the conductivity may decrease due to increased ion-ion interactions and viscosity), to provide suitable levels of salt dissociation and ion mobility (for a given lithium salt, there is a minimum threshold concentration, below which the salt may not fully dissociate, leading to a lack of charge carriers; conversely, there is a maximum threshold concentration, beyond which the increased ion-ion interactions hinder ion mobility sufficiently to reduce conductivity), to provide a target electrolyte viscosity, to target a predetermined electrochemical stability window, and/or to influence the formation and composition of a solid electrolyte interphase (SEI) layer on the anode. In some embodiments, the lithium salts is formed to a concentration of 0.1 M to 2 M, for example, 0.8 M, although other concentrations are within the contemplated scope of this disclosure.

As further shown in FIGS. 2B and 2C, the gas adsorbers 212 can be positioned on one or both of the anode layer 206 and the cathode layer 210. Other configurations are possible, and alternative configurations are disclosed herein with respect to FIGS. 3 and 4.

In some embodiments, the gas adsorber 212 is made of a gas adsorbent material selected to target, based on the respective cell chemistry of the battery cell 202 (e.g., the material selection of the anode layer 206 and the cathode layer 210, the chosen electrolyte, etc.), to convert at least a portion of a targeted offgas formed by the battery cell 202 to a solid phase. In some embodiments, the targeted offgas is the major gas species component of the cycling gasses. In some embodiments, the gas phase byproduct is produced when storing the battery cell. In some embodiments, the gas phase byproduct is produced when cycling and/or storing the battery cell. In some embodiments, the targeted offgas is carbon dioxide (CO₂). In some embodiments, the gas adsorbent material includes an alkaline earth oxide (e.g., MgO, CaO, BaO, SrO, BeO, etc.), which reacts with carbon dioxide (a gas at cycling and storing conditions) to form an alkaline earth metal carbonate such as MgCO₃, CaCO₃, etc. Notably, alkaline earth metal carbonates are solid-phase materials at operating conditions of the battery cell 202 (that is, at the temperatures and pressures present when cycling and/or storing the battery cell 202).

The use of alkaline earth oxides in the gas adsorber 212 is merely illustrative of the general concept, and other materials are possible. For example, the gas adsorber 212 can include zeolite, mixed oxides, porous foam, etc., or any other material which satisfies the following conditions: first, the material must react with the targeted offgas (e.g., CO₂) to produce a solid-phase material (e.g., MgCO₃); and second, the material should itself be a solid- or liquid-phase material (e.g., BaO is a powder over the range of cycling and/or storage conditions of the battery cell 202). While not meant to be particularly limited, in some embodiments, the mass percent of the gas adsorber 212 in the battery cell 202 is less than 5 percent, or less than 3 percent, or less than 1 percent the total mass of the battery cell 202.

In some embodiments, the gas adsorber 212 is applied as a blend and/or coating in (or on) the anode layer 206 and/or cathode layer 210. The processes used for applying the gas adsorber 212 to the anode layer 206 and/or cathode layer 210 are not meant to be particularly limited, but can include, for example, slurry coating, a spray dry method, atomic layer deposition (ALD), pulsed laser deposition (PLD), and electrodeposition.

For a slurry coating implementation, gas adsorber material can be incorporated into an electrode slurry (not separately shown) along with the active material(s), conductive additive(s), and binder(s). The slurry can then be coated directly onto a current collector foil (e.g., copper for an anode, aluminum for a cathode, etc.) using techniques such as doctor blade coating, slot-die coating, and reverse roll coating. After drying and calendering, the gas adsorber material is dispersed within the electrode coating. In this type of implementation, the gas adsorber 212 and the anode layer 206 and/or cathode layer 210 are formed as a single, blended material layer (this configuration is not separately shown).

For a spray dry implementation, gas adsorber material can be mixed with active material(s), conductive additive(s), and binder(s) in a solvent to form a slurry or solution. The resulting mixture can then be spray-dried to form composite particles containing gas adsorber material and the composite particles can be subsequently processed into an electrode coating using standard electrode manufacturing techniques. Alternatively, or in addition, gas adsorber material can be spray-dried directly onto an underlying substrate (e.g., the anode layer 206, the cathode layer 210, the separator 208, etc.), thereby forming a distinct gas adsorber 212. For example, the gas adsorber 212 can be formed in this manner directly on the separator 208 (as shown in FIG. 2B).

ALD and PLD, like the spray dry implementation, result in forming a distinct gas adsorber 212 on an underlying substrate. ALD is a vapor phase deposition technique that can be used to deposit thin films of the gas adsorber material on the surface of an electrode coating or directly onto active material particles. The ALD process involves sequential, self-limiting surface reactions, allowing for precise control over the thickness and uniformity of the deposited film. ALD can be performed on an electrode coating after the electrode manufacturing process or on the active material particles before electrode fabrication. PLD is a physical vapor deposition technique that uses a high-power pulsed laser to ablate a target material (the gas adsorber) and deposit a thin film onto an electrode surface. The laser pulses vaporize the target material, which then condenses onto the electrode substrate in a controlled manner. PLD can be used to deposit gas adsorber coatings on an electrode surface after electrode manufacturing or on active material particles before electrode fabrication.

For electrode materials that are electrically conductive, electrodeposition can be employed to deposit the gas adsorber material directly onto the electrode surface. In this implementation, gas adsorber material can be deposited onto a working electrode in an electrochemical cell from a suitable electrolyte solution containing precursor ions. The resulting coating thickness and properties can be varied as needed by controlling the deposition parameters, such as current density and deposition time.

Of course, the choice of coating/application technique for the gas adsorber 212 will depend on factors such as the compatibility of the chosen gas adsorber material with the electrode components, the desired coating thickness, and uniformity, scalability, and cost considerations. Moreover, in some embodiments, application of the gas adsorber 212 can require various post-treatment steps, such as heat treatment or surface modification, to enhance the adhesion, stability, and performance of the gas adsorber 212.

In some embodiments, the gas adsorber 212 is applied over an entire surface of an underlying substrate (e.g., the anode layer 206, the cathode layer 210, the separator 208, etc.). In some embodiments, the gas adsorber 212 is applied selectively to a portion of an underlying substrate (e.g., the anode layer 206, the cathode layer 210, the separator 208, etc.). For example, in some embodiments, the gas adsorber 212 is applied to an outer edge 214 of an underlying substrate, thereby forming a perimeter around one or more layers of the battery cell 202. FIG. 2C illustrates an embodiment where such a perimeter is formed around the anode layer 206. Other configurations are possible. For example, a perimeter can be similarly formed over any number (some, all) of the layers/components of the battery cell 202.

FIG. 3 illustrates a view of an alternative embodiment of the battery cell 202 shown in FIG. 2A in accordance with one or more embodiments. As shown in FIG. 3, the battery cell 202 can be implemented in a so-called prismatic can configuration having an outer case 302 and battery terminals 304. In some embodiments, the outer case 302 is a hard material, such as aluminum, plastic, stainless steel, etc. The battery configuration shown in FIG. 3 is merely illustrative. In other embodiments, the battery cell 202 can be implemented in a soft-wall type configuration, such as a battery pouch (refer to FIG. 2A).

In some embodiments, an electrode stack 306 is placed within the outer case 302. In some embodiments, electrode stack 306 includes one or more anode layer(s) 206, one or more separator(s) 208, and one or more cathode layer(s) 210, as described previously with respect to FIG. 2B. However, in some embodiments, in contrast to the embodiment shown in FIG. 2B, the electrode stack 306 does not include gas adsorber(s) 212.

Instead, in some embodiments, gas adsorber 212 is implemented as a separate packet (or package) 308 housed within the outer case 302. In some embodiments, packet 308 includes gas adsorber materials as described previously herein. In some embodiments, packet 308 is placed in parallel with the electrode stack 306, or alternatively, within a gap (or space) 310 between the electrode stack 306 and the outer case 302. The packet 308 can be placed directly on or against the electrode stack 306, or can be separated from the electrode stack 306 using a filling material (not separately shown), as desired. While the size and/or configuration of the packet 308 is not meant to be particularly limited, in some embodiments, the mass percent of the packet 308 in the battery cell 202 is less than 5 percent, or less than 3 percent, or less than 1 percent the total mass of the battery cell 202.

In some embodiments, packet 308 includes gas adsorber materials housed within gas permeable packaging materials (not separately shown). The packaging materials are not meant to be particularly limited, but can include materials selected for permeability with respect to a targeted offgas (e.g., CO₂). In some embodiments, the packaging materials for the packet 308 include gas-permeable modified atmosphere packaging (MAP) and/or controlled atmosphere packaging, for example, micro-perforated or microporous films such as polyethylene (PE) and polypropylene (PP) with micro-sized (e.g., sub millimeter) perforations or pinholes to allow the exchange of gases like CO₂ across the package interface. The size and density of the perforations can be controlled to achieve any desired gas transmission rate. Other materials include polymeric films with inherent porosity such as polyvinyl chloride (PVC) or polyvinylidene chloride (PVdC) films, cellulose-based materials such as cellophane, and woven or non-woven fabrics, such as those made from natural fibers including cotton and synthetic fibers such as polypropylene.

FIG. 4 illustrates a view of yet another alternative embodiment of the battery cell 202 shown in FIG. 2A in accordance with one or more embodiments. As shown in FIG. 4, the battery cell 202 can be implemented in a prismatic can configuration having an outer case 302 and battery terminals 304, in a similar manner as discussed previously with respect to FIG. 3. In some embodiments, the battery cell 202 can include one or more vents 402 positioned along the outer case 302. Advantageously, the vents 402 can allow excess gas (e.g., CO₂) to escape across the outer case 302. However, in contrast to the prismatic can configuration shown in FIG. 3, where gas adsorber 212 is implemented as a separate packet 308, in some embodiments, gas adsorber 212 is implemented as a powder filling material 404 disbursed within the outer case 302 of the battery cell 202.

In some embodiments, powder filling material 404 is disbursed within the outer case 302 to partially or fully fill a gap 310 between the electrode stack 306 and the outer case 302. The powder filling material 404 can be filled to a volume of between 5 percent and 100 percent the free volume in the gap 310 (that is, the available volume in the gap 310 prior to filling with the powder filling material 404). For example, in some embodiments, powder filling material 404 can be filled to a volume of 70 percent the free volume in the gap 310. Additionally, or alternatively, in some embodiments, powder filling material 404 can be coated onto an inner surface 406 of the outer case 302. Inner surface 406 is depicted as one inner surface of the outer case 302 for convenience only. Any internal surface and/or sidewall of the outer case 302 can be similarly coated, as desired, and all such configurations are within the contemplated scope of this disclosure. The inner surface 406 can be coated with powder filling material 404 using slurry coating, spray drying, ALD, PLD, and electrodeposition, in a similar manner as discussed previously with respect to gas adsorber 212.

Aspects of the embodiment shown in FIG. 4 can be applied to other battery cell configurations as desired. For example, in some embodiments, gas adsorber 212 can be implemented as a powder filling material 404 disbursed within a pouch cell type battery cell 202 and/or coated along an inner surface(s) of the pouch cell type battery cell 202 (these configurations are not separately shown).

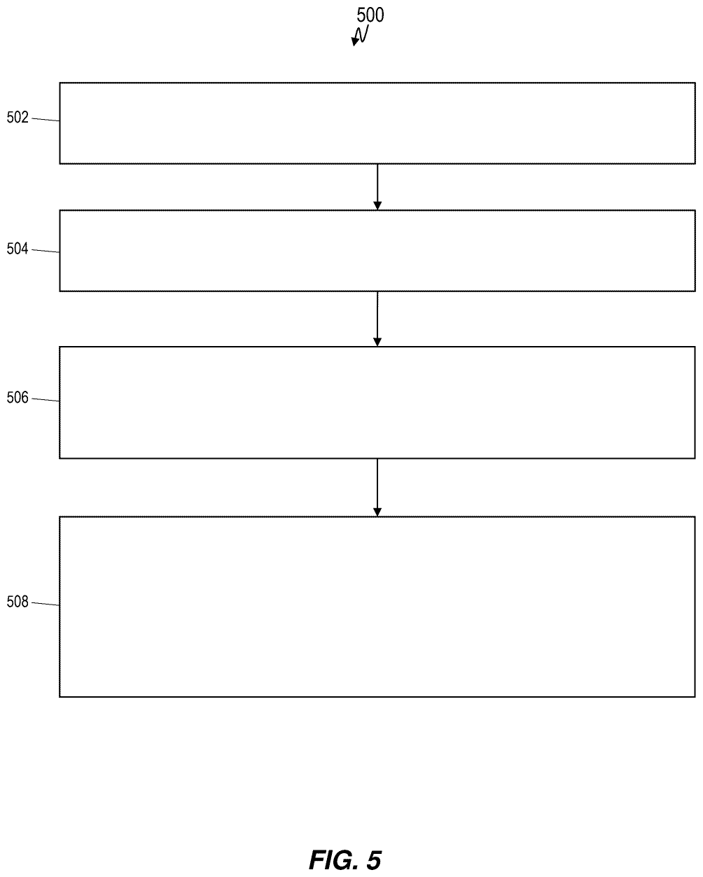

Referring now to FIG. 5, a flowchart 500 for manufacturing lithium-ion cells with gas adsorbers is generally shown according to an embodiment. The flowchart 500 is described in reference to FIGS. 1-4 and may include additional steps not depicted in FIG. 5. Although depicted in a particular order, the blocks depicted in FIG. 5 can be rearranged, subdivided, and/or combined.

At block 502, the method includes forming an anode layer having an anode active material and an anode current collector.

At block 504, the method includes forming a cathode layer having a cathode active material and a cathode current collector.

At block 506, the method includes forming a separator positioned between the anode layer and the cathode layer.

At block 508, the method includes forming a gas adsorber having a gas adsorbent material. In some embodiments, the gas adsorbent material is selected to react with at least one offgas that includes a gas phase byproduct produced by the battery cell to form a compound having a solid phase under an operating temperature and an operating pressure of the battery cell. In some embodiments, the gas phase byproduct is produced when cycling the battery cell and the operating temperature and operating pressure are a cycling temperature and a cycling pressure, respectively. In some embodiments, the gas phase byproduct is produced when storing the battery cell and the operating temperature and operating pressure are a battery storage temperature and a battery storage pressure, respectively.

In some embodiments, the offgas is carbon dioxide. In some embodiments, the gas adsorbent material includes an alkaline earth oxide. In some embodiments, the alkaline earth oxide includes one or more of magnesium oxide (MgO), calcium oxide (CaO), barium oxide (BaO), strontium oxide (SrO), or Beryllium oxide (BeO). In some embodiments, the gas adsorbent material includes one or more of an alkaline earth oxide, zeolite, or porous foam.

In some embodiments, the compound includes an alkaline earth metal carbonate.

In some embodiments, the gas adsorbent material includes a mass percent in the battery cell that is less than 5 percent, or 3 percent, or 1 percent a total mass of the battery cell.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor; and
a battery pack electrically coupled to the electric motor, the battery pack comprising a plurality of battery cells, each battery cell of the plurality of battery cells comprising:
at least one anode layer comprising an anode active material and an anode current collector;
at least one cathode layer comprising a cathode active material and a cathode current collector;
a separator positioned between the anode layer and the cathode layer; and
a gas adsorber comprising a gas adsorbent material, the gas adsorbent material selected to react with at least one offgas comprising a gas phase byproduct produced by the battery cell to form a compound having a solid phase under an operating temperature and an operating pressure of the battery cell.

2. The vehicle of claim 1, wherein the offgas comprises carbon dioxide.

3. The vehicle of claim 2, wherein the gas adsorbent material comprises an alkaline earth oxide.

4. The vehicle of claim 3, wherein the alkaline earth oxide comprises one or more of magnesium oxide (MgO), calcium oxide (CaO), barium oxide (BaO), strontium oxide (SrO), or Beryllium oxide (BeO).

5. The vehicle of claim 3, wherein the compound comprises an alkaline earth metal carbonate.

6. The vehicle of claim 1, wherein the gas adsorbent material comprises one or more of an alkaline earth oxide, zeolite, or porous foam.

7. The vehicle of claim 1, wherein the gas adsorbent material comprises a mass percent in a battery cell that is less than 1 percent a total mass of the battery cell.

8. A battery cell comprising:
an anode layer comprising an anode active material and an anode current collector;
a cathode layer comprising a cathode active material and a cathode current collector;
a separator positioned between the anode layer and the cathode layer; and
a gas adsorber comprising a gas adsorbent material, the gas adsorbent material selected to react with at least one offgas comprising a gas phase byproduct produced by the battery cell to form a compound having a solid phase under an operating temperature and an operating pressure of the battery cell.

9. The battery cell of claim 8, wherein the offgas comprises carbon dioxide.

10. The battery cell of claim 9, wherein the gas adsorbent material comprises an alkaline earth oxide.

11. The battery cell of claim 10, wherein the alkaline earth oxide comprises one or more of magnesium oxide (MgO), calcium oxide (CaO), barium oxide (BaO), strontium oxide (SrO), or Beryllium oxide (BeO).

12. The battery cell of claim 10, wherein the compound comprises an alkaline earth metal carbonate.

13. The battery cell of claim 8, wherein the gas adsorbent material comprises one or more of an alkaline earth oxide, zeolite, or porous foam.

14. The battery cell of claim 8, wherein the gas adsorbent material comprises a mass percent in the battery cell that is less than 1 percent a total mass of the battery cell.

15. A method comprising:
forming an anode layer comprising an anode active material and an anode current collector;
forming a cathode layer comprising a cathode active material and a cathode current collector;
forming a separator positioned between the anode layer and the cathode layer; and
forming a gas adsorber comprising a gas adsorbent material, the gas adsorbent material selected to react with at least one offgas comprising a gas phase byproduct produced by a battery cell to form a compound having a solid phase under an operating temperature and an operating pressure of the battery cell.

16. The method of claim 15, wherein the offgas comprises carbon dioxide.

17. The method of claim 16, wherein the gas adsorbent material comprises an alkaline earth oxide.

18. The method of claim 17, wherein the alkaline earth oxide comprises one or more of magnesium oxide (MgO), calcium oxide (CaO), barium oxide (BaO), strontium oxide (SrO), or Beryllium oxide (BeO).

19. The method of claim 17, wherein the compound comprises an alkaline earth metal carbonate.

20. The method of claim 15, wherein the gas adsorbent material comprises a mass percent in the battery cell that is less than 1 percent a total mass of the battery cell.
